(19) United States
(12) Patent Application Publication
(10) Pub. No.: US 2009/0064894 A1
(43) Pub. Date: Mar. 12, 2009

(54) WATER BASED HYDROPHOBIC SELF-CLEANING COATING COMPOSITIONS

(75) Inventors: Richard J. Baumgart, Paris, KY (US); Subbareddy Kanagasabapathy, Lexington, KY (US); Frances E. Lockwood, Georgetown, KY (US)

Correspondence Address: WOOD, HERRON & EVANS, LLP, 2700 CAREW TOWER, 441 VINE STREET, CINCINNATI, OH, 45202, US

(73) Assignee: ASHLAND LICENSING AND INTELLECTUAL PROPERTY LLC, Dublin, OH (US)

(21) Appl. No.: 12/204,432

(22) Filed: Sep. 4, 2008

Related U.S. Application Data
(60) Provisional application No. 60/967,441, filed on Sep. 5, 2007.

(51) Int. Cl. C09D 7/12; C08L 83/06; C08L 67/00; B65B 1/04

(52) U.S. Cl. 106/18.32; 106/287.35; 106/287.34; 106/287.19; 106/287.18; 106/287.1; 106/287.11; 106/287.24; 106/285; 106/287.26; 106/287.23; 524/588; 106/287.2; 524/599; 106/271; 106/287.3; 106/287.17; 106/15.05; 141/3

(57) ABSTRACT

A coating composition comprising hydrophobic particles having an average size of between 7 nm and 4,000 nm and a wetting agent for promoting dispersion of the hydrophobic particles in water. The hydrophobic particles may be oxides, such as silica, titania, or zinc oxide. In one embodiment, the hydrophobic particles comprise fumed silica. The coating composition may be brushed, spin coated, or dipped onto a surface. In one embodiment, once the coating composition dries, the coating formed thereby is characterized by a contact angle formed with a water droplet in excess of 165 degrees. A method of making a coating composition comprising providing hydrophobic particles having an average size of between 7 nm and 4,000 nm, mixing a wetting agent with the hydrophobic particles to form a paste, and dispersing the paste in water by mixing to form a mixture.

### CROSS-REFERENCE TO RELATED APPLICATIONS

This application claims the benefit of co-pending U.S. Provisional Application No. 60/967,441 filed on Sep. 5, 2007, the disclosure of which is incorporated by reference herein in its entirety.

### TECHNICAL FIELD

The present invention relates to water-based super-hydrophobic coating composition that when applied to a surface produces a self-cleaning surface.

### BACKGROUND OF THE INVENTION

This invention relates to appearance, maintenance, enhancement, and protection of various surfaces from contaminants and from oxidation of surfaces in air and corrosion by moisture. One of the primary applications includes the use of this technology in vehicle appearance products. Although products for similar applications are widely available on the market, these products often require rinsing with water after use and usually rely on a temporary hydrophilic surface. Typically, when the water dries from the surface, water marks, smears, or spots are left behind due to the deposits of minerals which were present as dissolved solids in water. This problem is apparent when cleaning glass, painted surfaces, steel, alloy, plastic, or ceramic surfaces. A means of solving this problem known in the literature is to dry the water from the surface using a cloth or chamois before the water marks form. However, this drying process is time consuming and requires considerable physical efforts.

The lotus plant exhibits self-cleaning properties because the surfaces of its leaves are covered with small nano-sized projections, bumps, or ridges. Surfaces exhibiting super-hydrophobic characteristics due to nano-sized irregularities thereof are often referred to as exhibiting the “Lotus Effect”. Super-hydrophobic coatings utilizing nano-sized irregularities applied to a surface form a high contact angle which resists wetting and adherence of dirt and contaminants.

The only commercially available hydrophobic materials for producing this non-wetting and self cleaning effect are fumed silica products sold under the trade name of MINCOR from BASF, and/or TEGOTOP from Degussa. Testing of the products has resulted in unsuitable coatings when applied to substrates. For example, it was found that the resulting coating is initially super-hydrophobic and may remain so for long periods indoors; however, when exposed to outdoor UV light, rubbed even slightly, or in general exposed to weather, the coating loses super-hydrophobicity within days, or, in some cases, the coating becomes hydrophilic.

There is, therefore, a need for a water-based coating composition that, when applied, is hydrophobic such that it prevents the appearance of water marks, inhibits corrosion, and prevents attachment of dirt and the like, and, furthermore, maintains its hydrophobicity even after exposure to the environment.

### SUMMARY OF THE INVENTION

In one embodiment, the instant invention is a coating composition having a small amount of hydrophobic particles dispersed in water. When applied to a surface, the hydrophobic particles have good adhesion to metals, glass, wood, plastic, painted and many other surfaces. The composition may not comprise any binding materials. While any particle that can be made hydrophobic will work, in one embodiment, the hydrophobic particles are oxides having a particle size of between 7 nm and 4,000 nm. A coating formed by applying the coating composition to a surface can be obtained by drying the film at room temperature for 5 to 10 minutes.

In one embodiment, the present invention provides a coating composition which is super-hydrophobic, and when applied to a surface, typically metal, fiberglass, plastic, ceramic, glass, wood, painted material, etc. produces a difficult-to-wet surface. A measurement of a contact angle (sometimes referred to as static contact angle) formed between a droplet of water and the surface is an indication of wettability. Geometrically, the contact angle is defined as the angle between the surface and a tangent along the liquid droplet's surface at the point of contact between the droplet and the surface. A contact angle of 0 defines complete wettability. In other words, a droplet will not form on the surface. At the other extreme, a contact angle of 180 degrees defines complete unwettability. The contact angle of water on the coated surface made according to the present invention may be difficult to measure with conventional means because the water droplet bounces or runs off the surface when applied. The inventors believe that the contact angle of a droplet of water on a surface formed of the coating composition, as described herein, exceeds 165 degrees and the tilt angle of sliding is less than 2 degrees. As set forth in Example 1, the surface energy for one embodiment of the coating is below 12 dynes/cm. This combined with creating the roughness to the surface brings the contact angle above 160 degrees.

In another embodiment, the coating composition contains super-hydrophobic nanoparticles, for example, treated fumed silica, dispersed in water. Although particles of other oxides may be suitable, namely those comprising titania or zinc oxide, if coated with a hydrophobic material, for example, silsesquioxanes and perfluoroacrylic resins, only a few polymers serve as an adequate base for the particles because the surface area of exposed polymer is vastly increased due to very thin film and rough surface area produced by the coating. Also, UV stability of the super-hydrophobic coatings is extremely important especially for exterior surfaces which are exposed to UV light.

A coating formed from the coating composition, may be transparent, uniform, and stable when exposed outdoors to extreme weather for a minimum time of one month, compared to 3 days for most other polymers including acrylates, urethane acrylates, homopolymers and copolymers of ethylenically unsaturated monomers, and acrylic acid/maleic anhydride copolymers known in the art. Stability is determined by observing that the unwettability, by measuring the contact angle of a droplet on the surface, has not diminished over the course of being exposed to the environment.

In order to disperse treated, silica or other oxide particles into water, the hydrophobic particles must be wetted by one or more non-aqueous liquids such as ketones, glycol ethers, glycol ether acetates, alcohols, aliphatic hydrocarbon solvents, polydimethylsiloxane, cyclic polydimethylsiloxane, aromatic hydrocarbon solvents, tetrahydrofuran, acetic acid, acetates, and glycols. A non-VOC material may be selected or a VOC exempt material may be selected to produce a non-VOC hydrophobic particle dispersion in water. Surfactants may also be used to help wet the surface in order to form a uniform super-hydrophobic coating. Surfactants can be nonionic, cationic, amphoteric, or anionic in nature.

As described herein, the coating composition provides a long-lasting transparent, removable self-cleaning super-hydrophobic coating that has the benefit of reducing drag, corrosion, water spotting, and will reduce icing caused by water drops. However, it should be noted that snow will cover horizontal surfaces but can be more easily removed from the surfaces protected with the invented coatings. Furthermore, the coating is inexpensive and can be periodically sprayed on the surface to renew the coating, if necessary.

The coating composition forms a substantially clear, dirt-repellent film or coating on painted material, plastic, metal, glass, ceramic, fiberglass, or polymer substrate. A preferred coating composition comprises an effective amount of a fumed silica wetted with a solvent and dispersed in water. When applied to a surface, the coating forms an unwettable surface having a contact angle of at least 165 degrees as compared to water having a contact angle of from 65 to 80 degrees on a noncoated surface. The coating composition also imparts a degree of hydrophobicity to the treated surface resulting in a tilt angle of sliding of less than 2 degrees as compared to water on a noncoated surface having a tilt angle of sliding of 90 degrees or higher.

The coating composition may be conveniently applied as an aerosol with or without a propellant. If propellant is used, it will generally be in an amount from about 10 wt % to about 100 wt % of the aerosol formulation. Normally, the amount of propellant should provide an internal pressure within a container from about 40 to 100 psig at 70° F. The suspended, treated silica particles generally will be in an amount from about 0.1 wt % to about 10 wt % of the aerosol formulation. To make the coating easier to apply, it can be wetted with a wetting agent prior to being dispersed in water. The wetting agent can be present in an amount in the range of 0.001 wt % to 2 wt %.

The coating formed from the coating composition solves the problem of poor resistance to UV light and/or abrasion found in previous coatings of similar nature. The coating may be transparent, near transparent, or translucent, which is unlike previous coatings of comparable hydrophobicity, which have all been white or opaque.

It is another object of the present invention to provide a self-cleaning coating composition containing particles that cures by evaporation of the water and does not require any special treatment, such as heating or exposing to IR or UV light to cure.

It is an object of the present invention to provide a hydrophobic self-cleaning composition which upon application to a surface forms a uniform coating by drying and evaporation of water forming a coating or film at ambient temperature within 5 to 10 minutes.

The hydrophobic coating composition forms an almost clear, translucent film or coating on painted material, plastic, metal, glass, wood, ceramic, fiberglass, or polymer substrate. A preferred coating composition comprising an effective amount of a treated fumed silica wetted in a solvent or wetting agent and dispersed in water that upon curing by evaporation will result in a coated surface providing a contact angle of at least 165 degrees.

It is an object of the present invention to apply the hydrophobic self-cleaning composition by conventional methods of application, such as by spraying, brushing, or dipping.

It is an object of the present invention to provide a self-cleaning coating which can be easily removed after being placed on a solid substrate, such as on paint, metal, plastic, concrete, natural and synthetic elastomers, and ceramics. The coating may be removed by washing with detergent or application of mechanical means such as brushing or applying pressure to the coating by high pressure sprays.

It is an object of the present invention to provide a water-based carrier for the self-cleaning hydrophobic coating for use on metal, plastic, glass, paper, or wood surfaces having existing protective coatings of paint, varnish, film, without damaging the existing protective coatings. In particular, the coating according to the present invention will not damage paint, chrome, plastic, fiberglass, or other substrates.

It is another object of the present invention to produce a self-cleaning hydrophobic coating which is easily to apply in the form of a liquid, foam, jell, paste, semi-solid, or aerosol.

A preferred composition utilizes a fumed silica compound, such as a hydrophobic fumed silica, in an amount of up to 10 percent by weight based on the total weight of the composition. Optionally, a fragrance can be added at about 0.10 percent by weight of the total composition to the formulation. In addition, depending on the method of application, a propellant can be added to the formulation. Other optional components which may be added to the composition, but are not required, include a colorant such as a dye or pigment in an effective amount of about 0.005 wt % based on the total composition. In another embodiment, a preservative such as SURCIDE P may be added in amount of about 0.1 percent by weight of the total composition.

It is an object of the present invention to provide a super-hydrophobic self-cleaning coating composition which can be sprayed in a broad range of surfaces using VOC complaint solvents for wetting the hydrophobic particles with or without aerosol propellants. For instance, a pressurized liquid propellant may be utilized as a carrier to apply the coating. The preferred embodiments of the present invention use a non-fluorinated propellant. A commercial liquid hydrocarbon propellant which is compatible with the preferred composition may be selected from the group of A-31, A-46, A-70, or A-108 propane/isobutane blends, with A-46 and A-70 being the most preferred propellant for use with particular compositions. Other propellants that can be used are carbon dioxide, nitrogen, and air. The composition may contain up to 25 wt % of the propellant, and more preferably from 5 to 20 wt % of the selected propellant.

It is an object of the present invention that the coating composition may be applied to non-porous and porous surfaces, such as those found in the automotive industry and those found in homes. For example, these surfaces may be from a portion of wheels, wheel trim, wheel covers, removable wheel covers, splash guards, car panels and painted surfaces, clear-coated car surfaces, metal, painted metal fixtures, chromed articles, bumpers, bumper stickers, bug deflectors, rain deflectors, vinyl materials including car boots, wheel covers, convertible tops, camper awnings, sun shades, vehicle covers, license plates, plastic articles, lens covers, signal light lens covering, brake light lens covering, headlamp and fog light lens, vinyl, rubber, plastic, leather surfaces, dashboard, dash instrument lens covering, seats, carpet, and floor runners.

It is an object of the present invention to be used for treating carpet, curtains, marble, granite, stone, brick, concrete, grout, mortar, drywall, spackling, plaster, adobe, stucco, unglazed tile, tile, unglazed porcelain, porcelain, clay, wallpaper, cardboard, paper, wood, and the like.

### DETAILED DESCRIPTION OF THE INVENTION

In one embodiment, the coating composition comprises hydrophobic particles. While any particle that can be made hydrophobic may be used, in one embodiment, the hydrophobic particles are made of oxides, for example, silica, titania, or zinc oxide. A variety of hydrophobic particles may be used if treated with a wetting agent, which allows the hydrophobic particles to be dispersed in water, as described below. As that term is used herein, super hydrophobic means the instant shedding of water with no remaining drops. Furthermore, for comparison purposes, the inventors note that water has a contact angle of from 65 to 80 degrees and a tilt angle of sliding of 90 degrees or higher on a noncoated surface.

In one embodiment, the hydrophobic particles are derived from the class of fumed silicas, titanias, and zinc oxides. These materials are commercially available from Degussa, Essen, Germany, and are sold as AEROSIL® R 8200, AEROSIL® R812 S, AEROSIL® R202, AEROXIDE® LE-1, AEROXIDE® LE-2, AEROXIDE® LE-3, and CAB-O-SIL TS 530, CAB-O-SIL® TS 610, and CAB-O-SIL® TS 720. The average particle size may be from about 7 nm to about 200 nm and more preferably from about 10 nm to about 100 nm.

As used herein, the term “particle” is intended to include any discrete particle, primary particle, aggregate and/or aggregated collection of primary particles, agglomerate and/or agglomerated collection of aggregates, colloidally dispersed particles, loose assemblies of particulate materials, and combinations thereof.

To make the coating composition easier to apply it can be wet by one or more wetting agents, preferably acetone and or aliphatic hydrocarbons and/or other VOC complaint solvents prior to dispersion in water to make it coatable. By way of example and not limitation, the wetting agent may also be a glycol, glycol ether, glycol ether acetate, an alcohol, a hydrocarbon, mineral spirits, or other hydrocarbons.

A preferred method of application is by spraying the dispersion as an aerosol. Suitable propellants are carbon dioxide, a hydrocarbon (for example mixtures of propane, butane and isobutane), a fluorocarbon, difluoroethane, or compressed air. One preferred hydrocarbon is a propane/isobutane.

A more detailed description of some of the ingredients utilized in the preferred embodiments of the self-cleaning hydrophobic compositions is as follows:

### Binders

The coating composition of the instant invention comprises a hydrophobic fumed particles wetted with a wetting agent and dispersed in a water-based carrier. Although not a requirement, a binder can be added as an option to the present composition and dispersed among the particles prior to wetting.

Although a variety of polymers will work if coated with a hydrophobic nanoparticles material, e.g., silsesquioxanes, perfluoroacrylic resins etc. only a few polymers serve as an adequate base for the particles. In one embodiment, the coating composition is resistant to abrasion and to the elements and particularly resist to UV light. As is known in the art, UV stability is important for exterior surfaces which are exposed to the sun.

The majority of the potential binders are not stable in the lotus-type coating and only careful selection of the binder and/or formulation with stabilizing additives will produce a practical lotus effect that is not easily destroyed by fog, UV light, or abrasion, e.g. by flowing water. Furthermore the polymers must be selected from the class that have hydrophobicity such that the contact angle of water on the polymer surface alone exceeds 120 degrees.

To that end, in one embodiment, the binder is UV stable and hydrophobic. By way of example, the binder may be trimethylsilyl end capped siloxanes, e.g., Wacker Polymer NA. These polymers can be combined with 0.1 to 5% of hydrophobic fumed silicas such as Aerosil® R8200 to form a super-hydrophobic coating. This coating is essentially a transparent, more uniform film that is stable when exposed outdoors to strong UV light, rain, wind, etc. for a minimum time of one month, compared to 3 days for most other polymers including acrylates, urethane acrylates, homopolymers and copolymers of ethylenically unsaturated monomers, acrylic acid/maleic anhydride copolymers, etc.

One embodiment of the present invention contains the binder in an effective amount of up to 2.0 wt % of the total weight of the coating composition. The more preferred embodiments of the invention utilize an amount ranging from 0.001 to 2.0 wt %, and more preferably in a range of from 0.001 to 1.5 wt %, more preferably in a range of from 0.01 to 1.5 wt %, more preferably in a range of from between 0.1 to 1.0 wt %, and more preferably between 0.1 to 0.5 wt % based on the total weight of the composition. One preferred embodiment, as set forth in Example 4, uses a binder polymer (aminofunctional siloxanes from Dow Corning) in an amount of about 0.3 wt % based on the total weight of the composition.

### Surface Modifier

The coating compositions in the examples are formulations that contain hydrophobic nanoparticles. Although a variety of nanoparticles will work if coated with a hydrophobic material, e.g., fumed silica and/or titania, perfluoroacrylic resins, etc. only few polymers serve as an adequate base for the particles because the surface area of exposed polymer is vastly increased due to very thin film and rough surface area produced by the coating.

It is believed the coating composition is a novel combination of synergistic components even without the addition of a hydrophobic fumed silica; however, a preferred embodiment of the present invention contains hydrophobic fumed silica having a median particle size in the range between 100 and 4,000 nm, more preferably in a range of from 100 to 3,000 nm, and more preferably in a range of from 100 to 1,000 nm in an effective amount of up to 5 wt % of the total composition as applied to the substrate in order to form a transparent or nearly transparent coating. Amounts in excess of 5.0 wt % can be used; however, the resulting dried coating will not be transparent, but will appear hazy. The more preferred embodiments utilize an effective amount of less than 5.0 wt %, and more preferably ranging from 0.001 to 5.0 wt %, and more preferably in a range of from to 0.01 to 4.5 wt % and more preferably in a range of from to 0.01 to 3.0 wt %, and more preferably in a range of from between 0.1 to 2.0 wt %, and more preferably between 0.1 to 0.5 wt % based on the total weight of the composition. One preferred embodiment as set forth in Example 1, uses nanoparticles of modified silica particles in an amount of about 0.25 wt % based on the total weight of the composition.

Nanoparticles that can be used to make the coatings of this invention are generally from the class of fumed silicas and hydrophobic titanias and zinc oxides, e.g., AEROSIL® R 8200, AEROSIL® R812 S, AEROSIL® R202, AEROXIDE® LE-1, AEROXIDE® LE-2, AEROXIDE® LE-3, and CAB-O-SIL TS 530, CAB-O-SIL® TS 610, and CAB-O-SIL® TS 720. In one embodiment, the composition of the present invention contains a hydrophobic fumed silica such as sold under the trade name of AEROXIDE® LE-3 to generate self-cleaning nanostructured hydrophobic surfaces which repel water. The average particle size distribution of particles is believed to be between 100 to 4,000 nm. The LE 3 brand has a specific surface area (BET) of 100 ±30 m²g, a carbon content of 3 to 6 weight percent, tapped density of approximately 60 g/l (According to (DIN EN ISO 787/11, August 1983), and a moisture of less than or equal to 1.0 weight percent (2 hours at 105° C.).

Suitable silica particles that may be used in the present invention include silica particles that have been hydrophobicized by any means known in the art. For example, colloidal silicon dioxide made from fumed silica by a suitable process to that reduces the particle size and modifies the surface properties. The surface properties are modified to produce fumed silica by production of the silica material under conditions of a vapor-phase hydrolysis at an elevated temperature with a surface modifying silicon compound, such as silicon dimethyl bichloride. Such products are commercially available from a number of sources, including Cabot Corporation, Tuscola, Ill. (under the trade name CAB-O-SIL® and Degussa, Inc., Piscataway, N.J. (under the trade name AEROSIL®).

Suitable modified fumed silica particles include, but are not limited to, those commercially available from Degussa Inc., Parsippany, N.J., as designated under the R Series of the AEROSIL® and AEROXIDE®LE trade names. The different AEROSIL®R and AEROXIDE®LE types differ in the kind of hydrophobic coating, the BET surface area, the average primary particle size, and the carbon content. The hydrophobic properties are a result of a suitable hydrophobizing treatment, e.g., treatment with at least one compound from the group of the organosilanes, alkylsilanes, the fluorinated silanes, and/or the disilazanes. Commercially available examples include AEROSIL®R 202, AEROSIL®R 805, AEROSIL® R 812, AEROSIL®R 812 S, AEROSIL® R 972, AEROSIL®R 974, AEROSIL® 8200, AEROXIDE®LE-1, and AEROXIDE® LE-2, and AEROXIDE® LE-3.

Other silica materials are also suitable when hydrophobically modified by use of hydrophobizing materials capable of rendering the surfaces of the silica particles suitably hydrophobic. The suitable hydrophobizing materials include all those common in the art that are compatible for use with the silica materials to render their surfaces suitably hydrophobic. Suitable examples, include, but are not limited to, the organosilanes, alkylsilanes, the fluorinated silanes, and/or the disilazanes. Suitable organosilanes include, but are not limited to, alkylchlorosilanes; alkoxysilanes, methyltrimethoxysilane, methyltriethoxysilane, ethyl trim ethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, noctyltriethoxysilane, phenyltriethoxysilane, polytriethoxysilane, trialkoxyarylsilanes, isooctyltrimethoxy-silane, N(3-triethoxysilylpropyl) methoxyethoxyethoxyethyl carbamate, polydialkylsiloxanes, polydimethylsiloxane, arylsilanes, substituted and unsubstituted arylsilanes, alkylsilanes substituted and unsubstituted alkyl silanes including, methoxy and hydroxy substituted alkyl silanes, and combinations thereof. Some suitable alkylchlorosilanes include, for example, methyltrichlorosilane, dimethyldichlorosilane, trim ethylchlorosilane, octylmethyldichlorosilane, octyltrichlorosilane, octadecylmethyldichlorosilane, and octadecyltrichlorosilane. Other suitable materials include, for example, methylmethoxysilanes, such as methyltrimethoxysilane; dimethyldimethoxysilane and trimethylmethoxysilane; methylethoxysilanes, such as methyltriethoxysilane; dimethyldiethoxysilane and trimethylethoxysilane; methylacetoxysilanes such as methyltriacetoxysilane, dimethyldiacetoxysilane and trimethylacetoxysilane; and vinylsilanes such as vinyltrichlorosilane, vinylmethyldichlorosilane, vinyldimethylchlorosilane, vinyltrimethoxysilane, vinylmethyldimethoxysilane, vinyldimethylmethoxysilane, vinyltriethoxysilane, vinylmethyldicthoxysilane and vinyldimethylethoxysilane.

Suitable disilazanes include for example, but are not limited to, hexamethyldisilazane, divinyltetramethyldisilazane, and bis(3,3-trifluoropropyl)tetramethyldisilazane. Cyclosilazanes are also suitable, and include, for example, octamethylcyclotetrasilazane. It is noted that the aforementioned disilazanes and cyclosilazanes typically have the basic formula (I) and (II) described above. Thus, these disilazanes and cyclosilazanes can be used as either or both as hydrophobizing material for hydrophobically modifying fumed silica particles and as a processing aid in forming the pre-dispersion mentioned supra.

Suitable fluorinated silanes include the fluorinated alkyl-, alkoxy-, aryl- and/or alkylarylsilanes, and fully perfluorinated alkyl-, alkoxy-, aryl- and/or alkylaryl-silanes. Examples of fluoroalkyl silanes include, but are not limited to, those marketed by Degussa under the trade name of DYNASYLAN. An example of a suitable fluorinated alkoxy-silane is perfluorooctyl trimethoxysilane.

### Zinc Oxide

A preferred embodiment of the present invention utilizes a nanometer sized zinc oxide powder. Its homogeneous small particles and narrow particle size distribution provides for excellent transparency. It is non-migratory and has antibacterial properties.

Regular commercially available zinc oxides have specific surface areas below 10 m²/gr, (typically 4-6 m²/gr), resulting in high primary particle sizes which results in white particle in appearance. The mean particle diameter of the zinc oxide utilized in the present invention is about 35 nm and the majority of the particles range from about 20 to 35 nm. One source of the nanometer sized zinc oxide, (ZANO® 20) is Umicore Zinc Chemicals in Belguim. One preferred embodiment utilizes zinc oxide particles having a specific surface area of minimum of 20 m²/gr, resulting in very fine loosely aggregated particles having a primary particle size below 60 nm providing a narrow particle size distribution allowing the zinc oxide to be used in transparent applications. Additional zinc oxide products available from Umicore Zinc Chemicals suitable for use in the present invention are sold under the trade name of ZANO®LS and has a specific surface area of 20-30 m²/gr and a primary particle size (calculated) of about 35-55 nm; and ZANO® HS which has a specific surface area of 30-40 m²/gr and a primary particle size (calculated) of about 25-35 nm. The homogeneous particle size distribution of the nanometer sized particle and its fine primary particle size result in good transparency. The nanometer sized zinc oxide particles are broad spectrum UV absorbers (UVA and UV-B) which is not the case for micro fine TiO₂ and organic UV absorbers. It also has anti-bacterial properties and is mildew resistant.

An alternate embodiment utilizes zinc oxide having an average particle size of 60 nm (calculated via SSA measurement) sold under the trade name of NANOGARD® by Nanophase Technologies Corporation, in Romeoville, Ill. Although it is sold as a white powder, the nanometer sized particles in low concentrations utilized in the preferred embodiments of the instant invention appear transparent.

The zinc oxide in at least one preferred embodiment of the present invention is present in an effective amount of up to 1.0 percent by weight of the total composition. The more preferred embodiments of the invention utilizes an effective amount ranging from 0.001 to 1.0 wt %, and more preferably in a range of from to 0.005 to 0.6 wt %, and more preferably in a range of from between 0.01 to 0.4 wt %, and more preferably between 0.05 to 0.2 wt % based on the total weight of the composition.

Another preferred class of UV and abrasion resistant hydrophobic polymers are the perfluoro alkyl substituted acrylic polymers. This class of polymers has excellent hydrophobicity and good abrasion resistance.

### Hydrocarbon Wetting Agents

In order to disperse hydrophobic silica or other hydrophobic particles into water, the hydrophobic particles must be wetted by a non-aqueous liquid, such as a ketone, glycol ethers, alcohols, aliphatic hydrocarbon solvents, polydimethylsiloxane, cyclic polydimethylsiloxane, aromatic hydrocarbon solvents, tetrahydrofuran, acetic acid, acetates, or glycols. The hydrophobic particles are easier to disperse after wetting with one or more solvents, preferably acetone, alcohol, isopropyl alcohol, aliphatic hydrocarbons, and/or other solvents to make it dispersible.

The hydrophobic particles are mixed with an amount of wetting agent to completely dampen the free flowing hydrophobic particles and may form a paste. A non VOC material may be selected or a VOC exempt material may be selected to produce a non VOC hydrophobic particle dispersion in water.

Wetting agents useful in the formulation are predominately aliphatic hydrocarbon solvents and other light distillates. For instance, hydrocarbons containing up to 100 percent aliphatic hydrocarbons are most preferable and hydrocarbons containing less than 1 percent aromatic content are deemed very desirable. Also useful are solvents typically containing from about 10 to 90 percent aliphatic hydrocarbons and from about 0 to 10 percent aromatic hydrocarbons. Solvents deemed suitable which contain less than 10 percent aromatic hydrocarbons include odorless mineral spirits, Stoddard solvent, and mixed alkanes that have a flash point of about 40° C. A light distillate sold under the trade name of CALUMET 420-460 (LVP 100), available from Calumet Lubricants Co., can be utilized in the composition.

Light distillate hydrocarbons containing up to 100% aliphatic hydrocarbons are most preferable and hydrocarbons containing less than 1% aromatic content are deemed very desirable. Also useful are solvents typically containing from about 10 to 90% aliphatic hydrocarbons and from about 0 to 10% aromatic hydrocarbons. Solvents deemed suitable which contain less than 10% aromatic hydrocarbons include odorless naphtha, mineral spirits, turpentine, kerosene, V.M.& P naphtha, Stoddard solvent, and mixed alkanes that have a flash point of about 40° C.

The present invention contains light distillate hydrocarbons in an effective amount of between 0.001 to 15 wt %, more preferably between 0.01 to 10 wt %, and more preferably 0.1 to 5 wt % based on the weight of the total composition. For instance, about 3 wt % acetone was used to wet the hydrophobic particles used in Example 1.

### Surfactant

Surfactants may also be used to help wet the metal surface in order to form a uniform super-hydrophobic coating. Surfactants can be nonionic, cationic, amphoteric, or anionic in nature.

One preferred surfactant, sold under the tradename of SURFYNOL 61, is dimethyl hexynol in an amount of 0.01 to 2 wt %. The surfactant helps in forming a film and wetting the surface to be coated with the water dispersion.

Other suitable surfactants include nonionic surfactants having an HLB value of from between 9-13, ethoxylated nonylphenols, ethoxylated octylphenols, branched ethoxylated alcohols, linear ethoxylated alcohols, and silicone surfactants. These surfactants are sold under the trade names of Tomah, Triton, Surfonic, Igepal, Alfonic, Rhodia, etc.

### Propellant

One method of application is by aerosol spraying. Applicable propellants include carbon dioxide, a hydrocarbon (for example, mixtures of propane isobutane), a fluorocarbon, difloroethane, nitrogen, or compressed air. One preferred hydrocarbon is A 55.

In one embodiment, a pressurized liquid propellant is utilized as the carrier to apply the composition without any further addition of carriers or solvents.

A commercial liquid hydrocarbon propellant can be selected which is compatible with the preferred composition. Propellants may be selected from blends of propane/isobutane/butane with the most preferred propellant as A 55 or A 70 for use with particular compositions. A commercial liquid hydrocarbon propellant is selected from the group consisting of A-3 1, A-46, A-55, A-70, or A-108, and/or propane/isobutane/butane blends, with A-55 and A-70 being the most preferred propellant for use with particular compositions. The composition may contain up to 30 wt % of the propellant, and more preferably from 5 to 20 wt % of the propellant. Moreover, the composition can be formulated as a premix liquid concentrate and mixed with a desired amount of propellant. For example, a typical formula may contain about 88 wt % of a premix liquid concentrate and about 12 wt % of a selected propellant. As an alternative, other propellants such as pressurized air, N₂, or CO₂ may also be used.

The composition may contain up to 99.9 wt % of propellant, and more preferably from 0 to 90 wt % of propellant and more preferably from about 80 to 90 wt % propellant.

### Dyes

As an option, a dye can be added to the composition to provide a desirable color or tint. Of course, it is contemplated that an effective amount could comprise more or less dye or tint up to 1% of the total weight of the composition.

Other colorants suitable for use in the instant composition include metallized azos, such as barium or calcium salts, naphthol, pyrazalones, rhodamines, quinacridones, phthalocyanincs, phthalocyanines, pigments including the magnesium salts, lead chromes and silicochromates, zinc chromes, barium chromate, strontium chromate, titanium nickel yellow, limonites, haematites, magnetites, micaceous oxides of iron, iron ferrites and Prussian blue.

### Preservatives

A biocide, such as DANTOGARD® (DMDM Hydantoin) or TROYSAN® 395 can be optionally used as a preservative in the product. The biocide is not a necessary component to provide a functional composition for use on surfaces; however, depending upon the optional ingredients added to the formulation, the preservative may increase the useful shelf life of the product. The biocide preservative would be added in an effective amount to preserve the composition product and ranges from 0.001 to 2.0 wt %, and more preferably in a range of from 0.05 to 1.0 wt %, and more preferably in a range of from between 0.1 and 0.5 wt % based on the total weight of the composition. Other preservatives such as polymethoxybicyclic oxazolidine, DANTOGARD (active ingredients 2,4-Imidazolidinedioone, 1,3-Bis (hydroxymethyl)-5,5-Dimethyl 1-(hydroxymethyl)-5,5 Dimethyl Hydantion, or SURCIDE P (active ingredient 1,3,5-triazine-1,3,5 (2H, 4H, 6H)-Triethanol (9CI)) may also be useful in the present invention.

### Application

The coating composition of the instant invention may be applied to a substrate surface by spraying, dipping, brushing, or spin-coating the surface being treated.

Stability was determined by observing that the super-hydrophobic effect has not diminished and by examining the film under the microscope before and after exposure.

In one preferred embodiment, the hydrophobic fumed silica nanoparticles are blended into the solvent until completely dispersed and then the zinc oxide nanoparticles are mixed until a good dispersion is obtained at ambient temperature. The mixture is then placed in an aerosol container with an effective amount of a propellant to spray the composition onto the surface to be treated. If used, a fragrance, colorant, or preservative is added prior to adding the composition to its container.

A preferred method of application is by spraying the particle dispersion as an aerosol. Suitable propellants are, for example, hydrocarbon of from 1 to 15 carbon atoms, such as npropane, n-butane, isobutane, n-pentane, isopentane, and mixtures thereof; and dimethyl ether and blend thereof as well as individual or mixtures of choloro-, chlorofluoro-, and/or difluoro or fluorohydrocarbons and/or hydrochlorofuorocarbons (HCFCs). Also suitable as propellant is compressed gas such as carbon dioxide, compressed air, nitrogen, and possibly dense or supercitical fluids may also be used, ether alone or combination, and alternatively and combination with other propellant types.

If propellant is used it will generally be in an amount from about 10 wt % to about 100 wt % of the aerosol formulation. Normally, the amount of a particular propellant should provide an internal pressure of about 40 to 100 psig at 70° F. The suspended treated silica generally will be in an amount from about 0.1 wt % to about 10 wt % of the aerosol formulation.

Wetting the hydrophobic particle with acetone and/or aliphatic hydrocarbons and/or other VOC complaint solvent makes it easier to disperse and apply or spray. The wetting agent may also be selected from the groups consisting of an alcohol, a hydrocarbon, mineral spirits, or glycol ether acetate.

One preferred method of treatment of a surface with the composition of the present invention is generally applied as an aerosol in a manner so as to deposit fine droplets of the composition comprising the colloidally dispersed hydrophobically modified fumed silica particles in water as a continuous coating upon a receptive surface such that the droplets completely cover the surface to effectively merge to form a thin continuous transparent film coating. The composition is applied as a substantially clear hydrophobic self-cleaning coating to a metal, plastic, glass, cloth, ceramic, clay, fiber, concrete, brick, rock, cinder block, paper, film, or wood surface. After application of a uniform coating to the treated surface, the composition cures by drying and evaporation of the water and wetting agent forming a coating or film at ambient temperature within 5 to 10 minutes of the application. The coating is essentially transparent. The uniform and transparent film is detachable and renewable. It exhibits dirt and water repellency owing to high water contact angles sufficient to shed water that is incident on the surface. As a result, the treated surface is self-cleaning.

The transparency and haze of the coating produced was measured by a HAZE GARD PLUS instrument, available from Paul N. Gardner Company, Inc., for a composition having a concentration of the silica in diluent.

| % Treated Fumed Silica | 0.3 | 0.5 | 0.8 | 1 | 2 | 4 |
|---|---|---|---|---|---|---|
| Transmittance (%) | 93.9 | 93.8 | 94.0 | 93.7 | 93.6 | 93.0 |
| Haze (%) | 2.35 | 3.26 | 3.26 | 3.2 | 4.05 | 4.36 |

### EXAMPLES

The following examples provide formulations of compositions in accordance with the present invention and provide examples of the range of ingredient percentages by weight providing an effective amount of the particular ingredients deemed necessary to obtain the desired results in a single application. The examples are provided for exemplary purposes to facilitate understanding of the invention and should not be construed to limit the invention to the examples.

### Example 1

### No Binder

A typical formulation of 0.3 wt % solid of fumed silica (Aerosil® R 8200) wetted by a weighting agent comprising glycol EB acetate in an amount of about 3 wt % together with a surfactant sold under the tradename of SURFYNOL 61, which is dimethyl hexynol, in an amount of 1 wt %. After wetting the fumed silica with the mineral spirits and surfactant, it was dispersed in water by ultrasonic sheering. The coating composition was coated onto a painted metal panel using aerosol propellent comprising from 80 to 90 wt % of A-70. The super-hydrophobic property was retained for more than 4 weeks when exposed to UV light, rain etc. before showing any degradation.

### Example 2

### No Binder

Another preferred embodiment formulation of 0.2 wt % solid of fumed silica (CAB-O-SIL® TS-720) that is wetted with acetone (3 wt %) and Tomadol 23.5 (0.05 wt %) forming a paste. This paste was then diluted with water (to 100%) and dispersed by ultrasonic sheering. The dispersion was then brush coated onto a painted metal surface. The coating exhibited excellent super-hydrophobic property (contact angle greater than 165 degrees). The super-hydrophobic property was maintained for more than 4 weeks under U V light, rain etc, before showing any signs of degradation.

### Example 3

### No Binder

Another preferred embodiment comprises a formulation of 0.05 wt % of a treated nanoparticle of ZnO and AEROXIDE® LE-3 at 0.5 wt %, a surfactant such as SURFYNOL 61 at 0.05 wt %, and Surfonic N-60 at 0.05 wt %, wetted with a wetting agent comprising acetone at about 3 wt % and the remaining water. The coating composition was coated on an unpainted metal surface by using a trigger sprayer. The film generated by this formulation showed excellent hydrophobic property (contact angle greater than 165 degrees). The super-hydrophobic property was maintained for more than 4 weeks under UV light, rain, etc before exhibiting signs of degradation.

### Example 4

### With Binder

Another preferred embodiment comprises a formulation of 0.3 wt % solid of fumed silica (Aerosil® R 202 from Degussa) and a surfactant such as Igepal DM-530 wetted with an isopropyl alcohol wetting agent in an amount of about 3 wt % and diluted with water. The formulation was similar to the formulation in Example I except that the instant example contains 0.1 wt % of binder (Beeswax) as a binder. The coating composition was applied to a painted metal surface using an air operated spray gun. The super-hydrophobic property (contact angle greater than 165 degrees) was maintained for more than 4 weeks under UV light, rain, etc. prior to showing any signs of degradation.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

What is claimed is:

1. A coating composition comprising:
hydrophobic particles having an average size of between 7 nm and 4,000 nm;
a wetting agent for promoting dispersion of the hydrophobic particles in water; and
water.

2. The coating composition of claim 1 wherein the hydrophobic particles are oxides.

3. The coating composition of claim 1 wherein the hydrophobic particles comprise silica, titania, or zinc oxide, or combinations thereof.

4. The coating composition of claim 1 wherein the hydrophobic particles comprise fumed silica.

5. The coating composition of claim 1 wherein the hydrophobic particles are present in an amount between 0.001 wt % and 10 wt % based on a total weight of the composition.

6. The coating composition of claim 1 wherein the hydrophobic particles are treated with an organosilane, an alkylsilane, a fluorinated silane, or a disilazane, or combinations thereof.

7. The coating composition of claim 1, wherein the wetting agent comprises a ketone, an aliphatic hydrocarbon, an alcohol, a glycol ether, a glycol ether acetate, a glycol, a polyglycol, a polydimethylsiloxane, a cyclic polydimethylsiloxane, an aromatic hydrocarbon solvent, a tetrahydrofuran, acetic acid, or an acetate, or a combination thereof.

8. The coating composition of claim 1, further comprising:
a surfactant.

9. The coating composition of claim 8 wherein the surfactant comprises a cationic surfactant, an amphoteric surfactant, a nonionic surfactant, or an anionic surfactant.

10. The coating composition of claim 8 wherein the surfactant comprises dimethlyhexynol, ethoxylated dinonyl phenol, 6-mole ethoxylate of nonylphenol, an ethoxylated octylphenol, a branched ethoxylated alcohol, a linear ethoxylated alcohol, or a silicone surfactant, or combinations thereof.

11. The coating composition of claim 1 further comprising:
a binder.

12. The coating composition of claim 11 wherein the binder is a UV stable hydrophobic polymer comprising a perfluoro alkyl substituted acrylic polymer, aminofunctional siloxanes, beeswax, or a trimethylsilyl end capped siloxane.

13. The coating composition of claim 1 further comprising:
a dye.

14. The coating composition of claim 13 wherein the dye comprises metallized azos, pigments, zinc chromes, barium chromate, strontium chromate, titanium nickel yellow, limonite, haematite, magnetite, micaceous oxides of iron, iron ferrite, or Prussian blue, or combinations thereof.

15. The coating composition of claim 1, further including:
a biocide.

16. The coating composition of claim 15 wherein the biocide comprises polymethoxybicyclic oxazolidine, DMDM hydantoin, or triazinetriethanol, or combinations thereof.

17. A method of making a coating composition, the method comprising:
providing hydrophobic particles having an average size of between 7 nm and 4,000 nm;
mixing a wetting agent with the hydrophobic particles to form a paste; and
dispersing the paste in water by mixing to form a mixture.

18. The method of claim 17 wherein dispersing includes ultrasonic sheering.

19. The method of claim 17 wherein the hydrophobic particles are oxides.

20. The method of claim 17 wherein the hydrophobic particles comprise silica, titania, or zinc oxide, or combinations thereof.

21. The method of claim 17 wherein the hydrophobic particles comprise fumed silica.

22. The method of claim 17 wherein providing includes providing the hydrophobic particles in an amount between 0.001 wt. % and 10 wt. % based on the total weight of the composition.

23. The method of claim 17 wherein providing the hydrophobic particles includes providing the hydrophobic particles treated with an organosilane, an alkylsilane, a fluorinated silane, or a disilazane, or combinations thereof.

24. The method of claim 17 wherein the wetting agent comprises a ketone, an aliphatic hydrocarbon, an alcohol, a glycol ether, a glycol ether acetate, a glycol, a polyglycol, a polydimethylsiloxane, a cyclic polydimethylsiloxane, an aromatic hydrocarbon solvent, a tetrahydrofuran, acetic acid, or an acetate, or a combination thereof.

25. The method of claim 17, further comprising:
mixing a surfactant into the water with the hydrophobic particles.

26. The method of claim 25 wherein the surfactant comprises a cationic surfactant, an amphoteric surfactant, a nonionic surfactant, and an anionic surfactant.

27. The method of claim 25 wherein the surfactant comprises dimethlyhexynol, ethoxylated dinonyl phenol, 6-mole ethoxylate of nonylphenol, an ethoxylated octylphenol, a branched ethoxylated alcohol, a linear ethoxylated alcohol, or a silicone surfactant, or combinations thereof.

28. The method of claim 17, further comprising:
mixing a UV stable hydrophobic polymer comprising a perfluoro alkyl substituted acrylic polymer, aminofunctional siloxanes, beeswax, or a trimethylsilyl end capped siloxane into the mixture.

29. The method of claim 17, further comprising:
mixing a dye into the mixture.

30. The method of claim 29 wherein the dye comprises metallized azos, pigments, zinc chromes, barium chromate, strontium chromate, titanium nickel yellow, limonite, haematite, magnetite, micaceous oxides of iron, iron ferrites, or Prussian blue, or combinations thereof.

31. The method of claim 17, further comprising:
mixing a biocide into the mixture.

32. The method of claim 31 wherein the biocide comprises polymethoxybicyclic oxazolidine, DMDM hydantoin, or triazinetriethanol, or combinations thereof.

33. The method of claim 17, further comprising:
placing the mixture in a container with a propellant comprising carbon dioxide, a hydrocarbon, nitrogen, fluorocarbon, difluoroethane, or compressed air, or combinations thereof.
